(19) United States
(12) Patent Application Publication
(10) Pub. No.: US 2025/0378995 A1
(43) Pub. Date: Dec. 11, 2025

(54) MULTILAYER CERAMIC CAPACITOR

(71) Applicant: Murata Manufacturing Co., Ltd., Nagaokakyo-shi (JP)

(72) Inventor: Kazuhiro NISHIBAYASHI, Nagaokakyo-shi (JP)

(21) Appl. No.: 19/311,407

(22) Filed: Aug. 27, 2025

Related U.S. Application Data
(63) Continuation of application No. PCT/JP2024/007530, filed on Feb. 29, 2024.

(30) Foreign Application Priority Data
Apr. 19, 2023 (JP) 2023-068357

(51) Int. Cl. H01G 4/012; H01G 4/232; H01G 4/248; H01G 4/30

(52) U.S. Cl. CPC H01G 4/012; H01G 4/232; H01G 4/248; H01G 4/30

(57) ABSTRACT

A multilayer ceramic capacitor includes a laminate including dielectric layers and internal electrodes. The internal electrodes include opposing portions, and extension portions extending to a lateral surface and/or an end surface of laminate. The extension portions include through-holes, and column portions in the through-holes. The column portions are made of a same material as the dielectric layers, and connect adjacent dielectric layers to each other in a lamination direction so as to sandwich the extension portions therebetween. When the direction in which the extension portions extend is defined as an extension direction, and a distance of extension of the extension portions toward the lateral surface or the end surface is defined as the extension distance, the dimension of the column portions, in the extension direction is from about 20% to about 80%.

### CROSS REFERENCE TO RELATED APPLICATIONS

This application claims the benefit of priority to Japanese Patent Application No. 2023-068357 filed on Apr. 19, 2023 and is a Continuation Application of PCT Application No. PCT/JP2024/007530 filed on Feb. 29, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

In general, multilayer ceramic capacitors each include a multilayer body in which dielectric layers and internal electrodes are alternately laminated. In order to further reduce the size and increase the capacitance of capacitors, attempts have been made to reduce the thickness of each of the dielectric layers, reduce the thickness of each of the internal electrodes, and increase the number of laminated layers (see, for example, Japanese Unexamined Patent Application, Publication No. 2018-041814).

However, as the number of electrode layers increases in order to increase the capacitance of capacitors, it becomes necessary to suppress the delamination between layers. In particular, in the extension region where the extension portions of the internal electrodes are provided, the internal stress difference between layers tends to increase, and the possibility of delamination between layers increases.

### SUMMARY OF THE INVENTION

Example embodiments of the present invention provide multilayer ceramic capacitors that are each able to reduce or prevent delamination between layers.

A multilayer ceramic capacitor includes a multilayer body including a plurality of dielectric layers that are laminated, a plurality of internal electrodes each on a corresponding one of the plurality of dielectric layers, two main surfaces opposed to each other in a lamination direction, two lateral surfaces opposed to each other in a width direction orthogonal or substantially orthogonal to the lamination direction, and two end surfaces opposed to each other in a length direction orthogonal or substantially orthogonal to the lamination direction and the width direction, and external electrodes connected to the plurality of internal electrodes on at least one of the two lateral surfaces or the two end surfaces, in which each of the plurality of internal electrodes includes a counter portion opposed to an adjacent one of the plurality of internal electrodes in the lamination direction, and an extension portion extending from the counter portion to at least one surface among the two lateral surfaces or the two end surfaces, the extension portion includes a through hole penetrating through the extension portion in the lamination direction, and a pillar portion in the through hole, including a dielectric material the same or substantially the same as that of the plurality of dielectric layers, and connecting dielectric layers adjacent to each other in the lamination direction among the plurality of dielectric layers with the extension portion interposed therebetween, when a direction in which the extension portion including the pillar portion extends from the counter portion is defined as an extension direction corresponding to the pillar portion, a cross section parallel or substantially parallel to the extension direction and the lamination direction and passing through a middle portion of the extension portion in a direction orthogonal or substantially orthogonal to the extension direction and the lamination direction is defined as a reference cross section, and a distance in which the extension portion extends from the counter portion toward one of the two lateral surfaces or the two end surfaces toward which the extension portion extends in the reference cross section is defined as an extension distance, a dimension of the pillar portion in the extension direction in the reference cross section is about 20% or more and about 80% or less of the extension distance.

According to example embodiments of the present invention, multilayer ceramic capacitors that are each able to reduce or prevent the delamination between layers are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1 according to a first example embodiment of the present invention.

FIG. 2 is a cross-sectional view of the multilayer ceramic capacitor 1 according to the first example embodiment of the present invention taken along the II-II direction in FIG. 1.

FIG. 3 is a cross-sectional view of the multilayer ceramic capacitor 1 according to the first example embodiment of the present invention taken along the III-III direction in FIG. 1.

FIG. 4 is a cross-sectional view along an end surface internal electrode 20 of the multilayer ceramic capacitor 1 according to the first example embodiment of the present invention.

FIG. 5 is a cross-sectional view along a lateral surface internal electrode 50 of the multilayer ceramic capacitor 1 according to the first example embodiment of the present invention.

FIG. 6 is a diagram showing manufacturing steps of a multilayer body 2 in a manufacturing method of the multilayer ceramic capacitor 1 according to the first example embodiment of the present invention.

FIG. 7 is a flowchart showing the manufacturing method of the multilayer ceramic capacitor 1 according to the first example embodiment of the present invention.

FIG. 8 is a schematic perspective view of a multilayer ceramic capacitor 100 according to a second example embodiment of the present invention.

FIG. 9 is a cross-sectional view of the multilayer ceramic capacitor 100 according to the second example embodiment of the present invention taken along the IX-IX direction in FIG. 8.

FIG. 10 is a cross-sectional view along an internal electrode 115A adjacent to one end surface of the multilayer ceramic capacitor 100 according to the second example embodiment of the present invention.

FIG. 11 is a cross-sectional view along an internal electrode 115B adjacent to the other end surface of the multilayer ceramic capacitor 100 according to the second example embodiment of the present invention.

### DETAILED DESCRIPTION OF THE EXAMPLE EMBODIMENTS

Example embodiments of the present invention will be described in detail below with reference to the drawings.

### First Example Embodiment

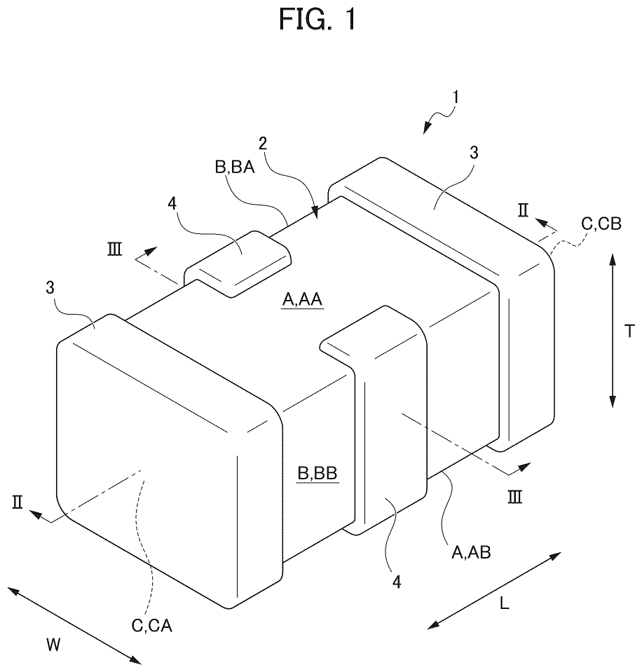

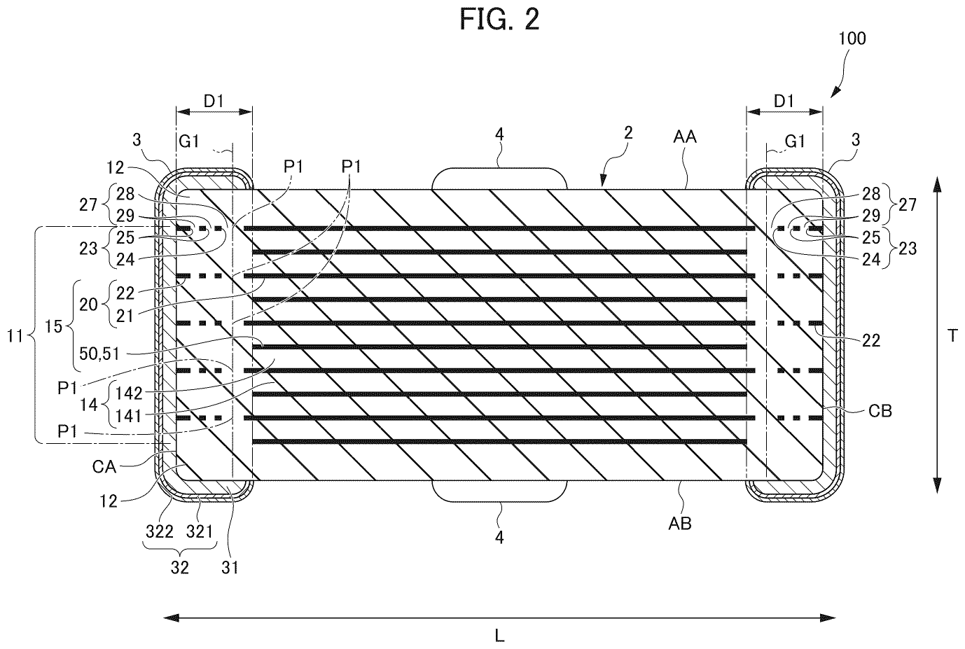

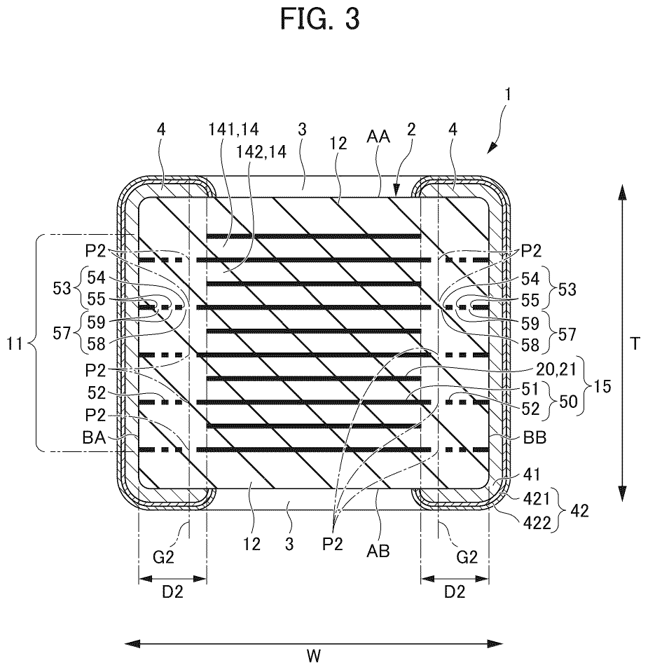

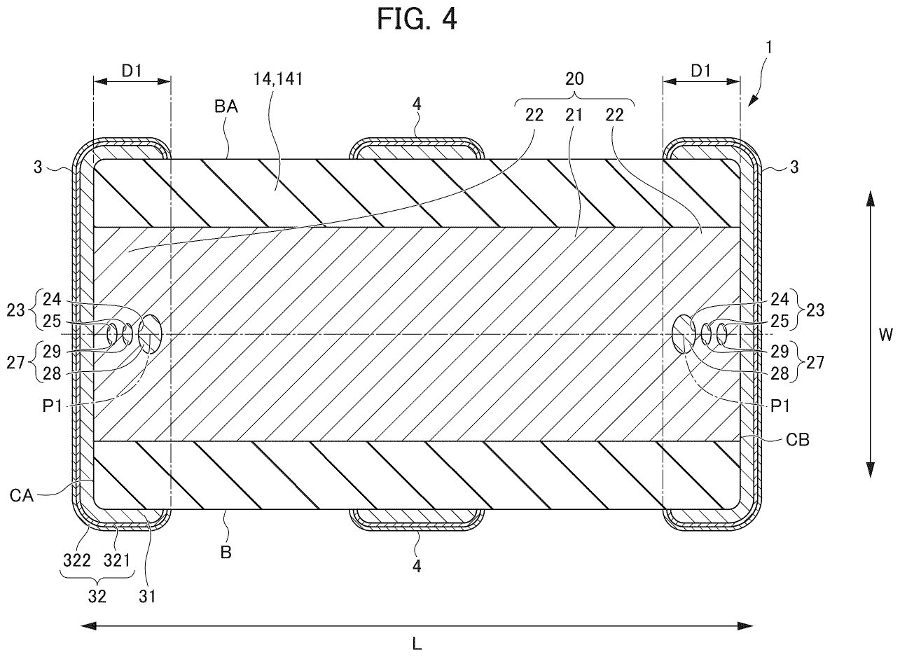

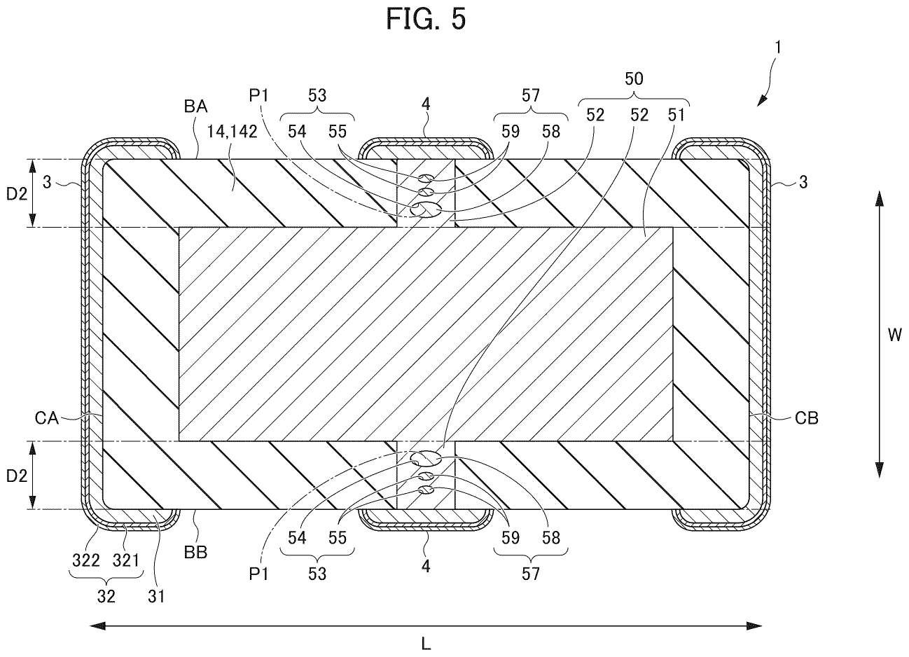

Hereinafter, a multilayer ceramic capacitor 1 according to a first example embodiment of the present invention will be described. FIG. 1 is a schematic perspective view of the multilayer ceramic capacitor 1. FIG. 2 is a cross-sectional view of the multilayer ceramic capacitor 1 taken along the II-II direction in FIG. 1. FIG. 3 is a cross-sectional view of the multilayer ceramic capacitor 1 taken along the III-III direction in FIG. 1. FIG. 4 is a cross-sectional view along an end surface internal electrode 20 of the multilayer ceramic capacitor 1. FIG. 5 is a cross-sectional view along a lateral surface internal electrode 50 of the multilayer ceramic capacitor 1.

### Multilayer Ceramic Capacitor 1

The multilayer ceramic capacitor 1 is a three-terminal multilayer ceramic capacitor 1 which includes a pair of end surface external electrodes 3 provided on both end surfaces C in the length direction L of the multilayer body 2, and a pair of lateral surface external electrodes 4 provided on both lateral surfaces B in the width direction W of the multilayer body 2. The multilayer body 2 includes an inner layer portion 11 in which dielectric layers 14 and internal electrodes 15 are laminated, and outer layer portions 12.

In the present specification, as terms indicating the orientations of the multilayer ceramic capacitor 1, the direction in which the dielectric layers 14 and the internal electrodes 15 are laminated in the multilayer ceramic capacitor 1 is defined as the lamination direction T. The direction intersecting the lamination direction T and in which the pair of end surface external electrodes 3 are provided is defined as the length direction L. The direction intersecting both the length direction L and the lamination direction T is defined as the width direction W. In the example embodiments, the lamination direction T, the length direction L, and the width direction W are orthogonal to each other.

In the following description, among the six outer surfaces of the multilayer body 2, a pair of outer surfaces provided on both sides in the lamination direction T are defined as main surfaces A, a pair of outer surfaces extending in the lamination direction T and provided on both sides in the width direction W are defined as lateral surfaces B, and a pair of outer surfaces extending in the lamination direction T and provided on both sides in the length direction L are defined as end surfaces C. One of the main surfaces A is defined as a main surface AA, and the other is defined as a main surface AB. One of the lateral surfaces B is defined as a lateral surface BA, and the other is defined as a lateral surface BB. One of the end surfaces C is defined as an end surface CA, and the other is defined as an end surface CB.

The cross section of FIG. 2 is a cross section parallel or substantially parallel to the length direction L and the lamination direction T and passing through the middle portion in the width direction W of the first extension portion 22, and corresponds to the first reference cross section and a reference cross section referenced in claim 1 of the claims. The cross section of FIG. 3 is a cross section parallel or substantially parallel to the width direction W and the lamination direction T and passing through the middle portion in the length direction L of the second extension portion 52, and corresponds to the second reference cross section and a reference cross section referenced in claim 1 of the claims.

### Multilayer Body 2

The multilayer body 2 includes an inner layer portion 11 and outer layer portions 12 provided on both sides of the inner layer portion 11 in the lamination direction T. The multilayer body 2 preferably has rounded corner portions and ridge portions. The corner portions are portions where three surfaces of the multilayer body intersect, and the ridge portions are portions where two surfaces of the multilayer body intersect.

### Inner Layer Portion 11

The inner layer portion 11 includes a plurality of dielectric layers 14 and a plurality of internal electrodes 15 laminated along the lamination direction T.

### Dielectric Layer 14

The dielectric layers 14 are each made of a ceramic material. As the ceramic material, for example, a dielectric ceramic with BaTiO₃ as a main component is used. Also, as the ceramic material, for example, one in which at least one subcomponent such as Mn compound, Fe compound, Cr compound, Co compound, Ni compound, etc., is added to these main components may be used.

### Internal Electrode 15

The internal electrodes 15 are each preferably made of a metal material such as, for example, Ni, Cu, Ag, Pd, Ag—Pd alloy, Au, or the like.

The internal electrodes 15 include a plurality of end surface internal electrodes 20 and a plurality of lateral surface internal electrodes 50 that are alternately provided with each other. The end surface internal electrodes 20 and the lateral surface internal electrodes 50 may be collectively referred to as “internal electrodes 15” when there is no particular need to distinguish between them. The internal electrodes 15 correspond to the internal electrodes referenced in claim 1 of the claims.

### End Surface Internal Electrode 20

As shown in FIG. 4, the end surface internal electrodes 20 each extend between both end surfaces C in the length direction L of the multilayer body 2 and are each spaced apart from both of lateral surfaces B in the width direction W by a certain distance. Each of the end surface internal electrodes 20 includes a first counter portion 21 opposed to the lateral surface internal electrode 50 adjacent in the lamination direction T, and first extension portions 22 extending from the first counter portion 21 and exposed at the two end surfaces C, respectively. Specifically, the first counter portion 21 is located in the middle portion between both end surfaces C. The length direction L corresponds to the extension direction of the first extension portions 22.

### Lateral Surface Internal Electrode 50

As shown in FIG. 5, the lateral surface internal electrodes 50 are each slightly smaller than the multilayer body 2 and spaced apart from both end surfaces C in the length direction L by a certain distance. The lateral surface internal electrodes 50 each include a second counter portion 51 that is opposed to the end surface internal electrode 20 adjacent in the lamination direction T, and second extension portions 52 that extend from the second counter portion 51 and are exposed at the two lateral surfaces B, respectively. Specifically, the second counter portion 51 is located in the middle portion between both lateral surfaces B. The width direction W corresponds to the extension direction of the second extension portion 52. When there is no particular need to distinguish between them, the first counter portion 21 and the second counter portion 51 are collectively referred to as “counter portions 21, 51”, and the first extension portion 22 and the second extension portion 52 are collectively referred to as “extension portions 22, 52”. The counter portions 21, 51 correspond to a counter portion referenced in claim 1 of the claims, and the extension portions 22, 52 correspond to an extension portion referenced in claim 1 of the claims.

The dielectric layers 14 include first dielectric layers 141 on which the end surface internal electrodes 20 are provided, respectively, and second dielectric layers 142 on which the lateral surface internal electrodes 50 are provided, respectively.

### Outer Layer Portion 12

Each of the outer layer portions 12 is a dielectric layer having a constant thickness provided adjacent to the main surface A of the inner layer portion 11 (see FIGS. 2 and 3). Each of the outer layer portions 12 is manufactured from the same material as the dielectric layer 14 of the inner layer portion 11.

### End Surface External Electrode 3

The pair of end surface external electrodes 3 are provided on both end surfaces C of the multilayer body 2, respectively. The first extension portions 22 are connected to each of the end surface external electrodes 3, respectively. Each of the end surface external electrodes 3 covers not only a corresponding one of the end surfaces C, but also a portion of the main surface A and a portion of the lateral surface B adjacent to the end surface C. Each of the end surface external electrodes 3 includes a base electrode layer 31 and a plated layer 32 provided on the base electrode layer 31. The plated layer 32 includes, for example, a Ni (nickel) plated layer 321 provided on the base electrode layer 31 and a Sn (tin) plated layer 322 provided on the Ni plated layer 321.

### Lateral Surface External Electrode 4

The pair of lateral surface external electrodes 4 are provided on both lateral surfaces B of the multilayer body 2, respectively. Each of the second extension portions 52 are connected to a corresponding one of the lateral surface external electrodes 4. Each of the lateral surface external electrodes 4 covers not only a corresponding one of the lateral surfaces B, but also a portion of the main surface A adjacent to the lateral surface B. Each of the lateral surface external electrodes 4 includes a base electrode layer 41 and a plated layer 42 provided on the base electrode layer 41. The plated layer 42 includes, for example, a Ni (nickel) plated layer 421 provided on the base electrode layer 41 and a Sn (tin) plated layer 422 provided on the Ni plated layer 421. The end surface external electrode 3 and the lateral surface external electrode 4 may be collectively referred to as “external electrodes 3, 4”. The external electrodes 3, 4 correspond to the external electrode referenced in claim 1 of the claims.

### First Extension Distance D1, First Reference Point P1, and First Gap Line G1

Here, in the cross section of FIG. 2, the distance that each first extension portion 22 extends from each first counter portion 21 toward one end surface C (that is, the dimension of the first extension portion 22 in the length direction L) is defined as the first extension distance D1 of each end surface internal electrode 20, and a point that is spaced apart from one end surface C from which the first extension portion 22 extends by a distance of ⅔ of the first extension distance D1 in each first extension portion 22 is defined as the first reference point P1 of each end surface internal electrode 20. A line in the lamination direction T connecting the first reference points P1 adjacent to each other in the lamination direction T is defined as the first gap line G1. It is preferable that the respective first extension distances D1 are the same or substantially the same. In that case, in the region adjacent to one end surface C of the multilayer ceramic capacitor 1, each first reference point P1 is located on the same straight line extending in the lamination direction T, and the first gap line G1 defines a straight line extending in the lamination direction T.

### First Through Hole 23 and First Pillar Portion 27

The first extension portions 22 each include a plurality of first through holes 23 penetrating in the lamination direction T. A dielectric that is the same as the material of the dielectric layer 14 is provided in each of the first through holes 23. In other words, the first extension portion 22 includes first pillar portions 27 that are each provided in a corresponding one of the first through holes 23, are each made of the same dielectric as the material of the dielectric layer 14, and each connecting the dielectric layers 14 adjacent to each other in the lamination direction T with the first extension portion 22 interposed therebetween. This makes it possible to reduce or prevent delamination between the first extension portions 22 and the dielectric layers 14 adjacent to the first extension portions 22. The dimension of each of the first through holes 23 in the length direction L and the dimension of each of the first pillar portions 27 in the length direction L are the same or substantially the same. Each of the first pillar portions 27 have a dimension in the length direction L in the cross section of FIG. 2 that is, for example, about 20% or more and about 80% or less of the first extension distance D1.

In the region near one end surface C (for example, end surface CA) in the cross section of FIG. 2, the first through holes 23 provided in one first extension portion 22 include a main first through hole 24 provided at a position including the first reference point P1, and sub first through holes 25 provided closer to the end surface CA than the main first through hole 24 is. The first pillar portions 27 provided in the one first extension portion 22 include a main first pillar portion 28 provided at a position including the first reference point P1, and sub first pillar portions 29 provided closer to the end surface CA than the main first pillar portion 28 is. The main first pillar portion 28 is located on the first gap line G1. This makes it possible to more effectively reduce or prevent delamination.

In the cross section of FIG. 2, it is preferable that the dimension in the length direction L of the main first through hole 24 and the main first pillar portion 28 is, for example, about ⅕ or more and about ⅘ or less of the first extension distance D1 of the first extension portion 22 in which the main first through hole 24 and the main first pillar portion 28 are provided.

In the cross section of FIG. 2, it is preferable that a plurality of sub first through holes 25 and a plurality of sub first pillar portions 29 are provided in one first extension portion 22. Among the plurality of sub first through holes 25 and the plurality of sub first pillar portions 29, it is preferable that the dimension in the length direction L of each of at least two or more sub first through holes 25 and sub first pillar portions 29 is smaller than the dimension in the length direction L of the main first through hole 24 and the main first pillar portion 28 provided in the first extension portion 22.

In a region of the multilayer body 2 near one end surface C, the first extension portions 22 and the dielectric layers 14 are alternately provided in the lamination direction T, and it is preferable that the first extension portions 22 including the first pillar portions 27 each provided at a position including the first reference point P1 (first gap line G1), and the dielectric layers 14 are alternately and continuously laminated for a number of layers accounting for, for example, about 3% or more of the total number of layers of the first extension portions 22 and the dielectric layers 14 alternately provided in the lamination direction T. In addition, the dielectric layer 14 sandwiched between two first extension portions 22 is considered as one layer even if it is a mixture of dielectrics derived from a plurality of ceramic green sheets. The number of outer layer portions 12 is not included in the number of dielectric layers 14.

It is preferable that the number of end surface internal electrodes 20 each provided with the first through holes 23 and the first pillar portions 27 is, for example, about ⅕ or more of the total number of end surface internal electrodes 20.

It is preferable that the end surface internal electrodes 20 adjacent to either main surface A are provided with the first through holes 23 and the first pillar portions 27. Specifically, among the end surface internal electrodes 20 included in each region adjacent to a corresponding one of both main surfaces A among the regions obtained by dividing the multilayer ceramic capacitor 1 into three equal portions in the lamination direction T, it is preferable that at least one end surface internal electrode 20 includes the first through holes 23 and the first pillar portions 27. By providing the first pillar portions 27 at positions adjacent to either main surface A, it is possible to more effectively reduce or prevent delamination.

It is preferable that the dimension in the lamination direction T of the end surface internal electrode 20 including the first pillar portion 27 (main first pillar portion 28) provided at a position including the first reference point P1 (first gap line G1) is, for example, about 0.1 μm or more and about 5.0 μm or less.

### Second Extension Distance D2, Second Reference Point P2, and Second Gap Line G2

In the region near one lateral surface B in the cross section of FIG. 3, the distance that each second extension portion 52 extends from each second counter portion 51 toward one lateral surface B (that is, the dimension of the second extension portion 52 in the width direction W) is defined as the second extension distance D2 of each lateral surface internal electrode 50, and a point that is spaced apart from one lateral surface B from which the second extension portion 52 extends by, for example, a distance of about ⅔ of the second extension distance D2 in each second extension portion 52 is defined as the second reference point P2 of each lateral surface internal electrode 50. A line in the lamination direction T connecting the second reference points P2 adjacent to each other in the lamination direction T further is defined as a second gap line G2. It is preferable that the respective second extension distances D2 are the same or substantially the same. In that case, in the region adjacent to one lateral surface B of the multilayer ceramic capacitor 1, each second reference point P2 is located on the same straight line extending in the lamination direction T, and the second gap line G2 defines a straight line extending in the lamination direction T.

When there is no particular need to distinguish therebetween, the first extension distance D1 and the second extension distance D2 are collectively referred to as “extension distance D”, and the first reference point P1 and the second reference point P2 are collectively referred to as “reference point P”. The extension distance D corresponds to an extension distance in claim 1 of the claims.

### Second Through Holes 53 and Second Pillar Portion 57

The second extension portions 52 each include a plurality of second through holes 53 penetrating in the lamination direction T. A dielectric that is the same as the material of the dielectric layer 14 is provided in each of the second through holes 53. In other words, the second extension portion 52 includes second pillar portions 57 that are each provided in a corresponding one of the second through holes 53, are each made of the same dielectric as the material of the dielectric layer 14, and each connecting the dielectric layers 14 adjacent to each other in the lamination direction T with the second extension portion 52 interposed therebetween. This makes it possible to reduce or prevent delamination between the second extension portions 52 and the dielectric layers 14 adjacent to the second extension portions 52.

The dimension of each of the second through holes 53 in the width direction W and the dimension of each of the second pillar portions 57 in the width direction W are the same or substantially the same. Each of the second pillar portions 57 have a dimension in the width direction W in the cross section of FIG. 3 that is, for example, about 20% or more and about 80% or less of the second extension distance D2. When there is no particular need to distinguish therebetween, the first through holes 23 and the second through holes 53 are collectively referred to as “through holes 23, 53”, and the first pillar portions 27 and the second pillar portions 57 are collectively referred to as “pillar portions 27, 57”. The through holes 23, 53 correspond to a through hole, and the pillar portions 27, 57 correspond to a pillar portion. It is not necessary that both of the first through holes 23 and first pillar portions 27 and the second through holes 53 and second pillar portions 57 are provided, and only one of them may be provided.

In the region near one lateral surface B (for example, lateral surface BA) in the cross section of FIG. 3, the second through holes 53 provided in one second extension portion 52 include a main second through hole 54 provided at a position including the second reference point P2, and sub second through holes 55 provided closer to the lateral surface BA than the main second through hole 54 is. The second pillar portions 57 provided in the one second extension portion 52 include a main second pillar portion 58 provided at a position including the second reference point P2, and sub second pillar portions 59 provided closer to the lateral surface BA than the main second pillar portion 58 is. The main second pillar portion 58 is located on the second gap line G2. This makes it possible to more effectively reduce or prevent delamination.

In the region near one lateral surface B in the cross section of FIG. 3, it is preferable that the dimension in the width direction W of the main second through hole 54 and the main second pillar portion 58 is, for example, about ⅕ or more and about ⅘ or less of the second extension distance D2 corresponding to the second extension portion 52 in which the main second through hole 54 and the main second pillar portion 58 are provided.

In the region near one end surface C in the cross section of FIG. 3, it is preferable that a plurality of sub second through holes 55 and a plurality of sub second pillar portions 59 are provided in one second extension portion 52. Among the plurality of sub second through holes 55 and the plurality of sub second pillar portions 59, it is preferable that the dimension in the width direction W of each of at least two or more sub second through holes 55 and sub second pillar portions 59 is smaller than the dimension in the width direction W of the main second through hole 54 and the main second pillar portion 58 provided in the second extension portion 52.

In the region near one lateral surface B of the multilayer body 2, the second extension portions 52 and the dielectric layers 14 are alternately provided in the lamination direction T, and it is preferable that the second extension portions 52 including the second pillar portions 57 each provided at a position including the second reference point P2 (second gap line G2), and the dielectric layers 14 are alternately and continuously laminated for a number of layers accounting for, for example, about 3% or more of the total number of layers of the second extension portions 52 and the dielectric layers 14 alternately provided in the lamination direction T. In addition, the dielectric layer 14 sandwiched between two second extension portions 52 is considered as one layer even if it is a mixture of dielectrics derived from a plurality of ceramic green sheets. The number of outer layer portions 12 is not included in the number of dielectric layers 14.

It is preferable that the number of lateral surface internal electrodes 50 each provided with the second through holes 53A and the second pillar portions 57A is, for example, about ⅕ or more of the total number of lateral surface internal electrodes 50.

It is preferable that the lateral surface internal electrodes 50 adjacent to any of the main surfaces A are provided with the second through holes 53 and the second pillar portions 57. Specifically, among the lateral surface internal electrodes 50 included in two regions adjacent to a corresponding one of both main surfaces A among regions obtained by dividing the multilayer ceramic capacitor 1 into three equal or substantially equal portions in the lamination direction T, it is preferable that at least one lateral surface internal electrode 50 includes the second through holes 53 and the second pillar portions 57. By providing the second pillar portion 57 at positions adjacent to either main surface A, it is possible to more effectively reduce or prevent delamination.

It is preferable that the dimension in the lamination direction T of the lateral surface internal electrode 50 provided with the second pillar portion 57 (main second pillar portion 58) on the second reference point P2 (second gap line G2) is, for example, about 0.1 μm or more and about 5.0 μm or less.

### Method of Manufacturing Multilayer Ceramic Capacitor 1

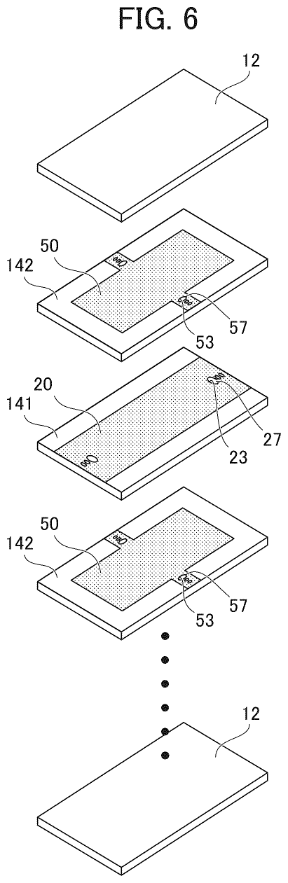

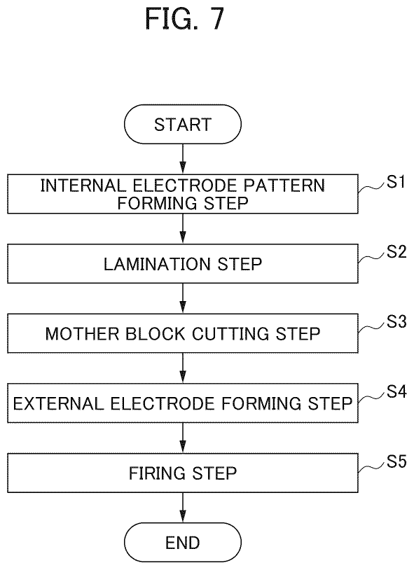

Next, an example of a method of manufacturing the multilayer ceramic capacitor 1 according to the first example embodiment will be described. FIG. 6 is a diagram explaining the manufacturing steps of the multilayer body 2 in the method of manufacturing the multilayer ceramic capacitor 1. FIG. 7 is a flowchart explaining the method of manufacturing the multilayer ceramic capacitor 1.

### Internal Electrode Pattern Forming Step S1

As shown in FIGS. 6 and 7, an electrically conductive paste is applied to a ceramic green sheet that defines and functions as the first dielectric layer 141 to form the end surface internal electrode 20. Similarly, an electrically conductive paste is applied to a ceramic green sheet that defines and functions as the second dielectric layer 142 to form the lateral surface internal electrode 50.

The ceramic green sheet is a strip-shaped sheet formed by molding a ceramic slurry including ceramic powder, binder, and solvent into a sheet shape on a carrier film using, for example, a die coater, gravure coater, microgravure coater, or the like.

The end surface internal electrodes 20 and the lateral surface internal electrodes 50 are formed by printing such as, for example, screen printing, gravure printing, relief printing, or the like. At this time, it is possible to form the first through hole 23 in the end surface internal electrode 20 or form the second through hole 53 in the lateral surface internal electrode 50 by using a printing pattern of the end surface internal electrode 20 in which the first through hole 23 is provided in advance or a printing pattern of the lateral surface internal electrode 50 in which the second through hole 53 is provided in advance. The method of forming the first through hole 23 and the second through hole 53 in the internal electrode 15 is not limited to this.

### Lamination Step S2

The ceramic green sheets that define and function as the first dielectric layers 141 on which the end surface internal electrodes 20 are provided and the ceramic green sheets that define and function as the second dielectric layers 142 on which the lateral surface internal 50 electrodes are provided are alternately laminated. A dielectric derived from the dielectric layers 14 is provided inside the first through hole 23 and inside the second through hole 53. Thus, the first pillar portion 27 and the second pillar portion 57 are formed. Subsequently, ceramic green sheets for manufacturing the outer layer portions are provided on the upper and lower sides, and thermocompression bonded to form a mother block.

### Mother Block Cutting Step S3

Next, the mother block is cut and divided in the length direction L and the width direction W to manufacture a plurality of rectangular or substantially rectangular parallelepiped multilayer bodies 2.

### External Electrode Forming Step S4

Next, the end surface external electrodes 3 are formed on both end surfaces C of the multilayer body 2, and the lateral surface external electrodes 4 are formed on both lateral surfaces B of the multilayer body 2. The first extension portions 22 of the end surface internal electrodes 20 are each connected to a corresponding one of the end surface external electrodes 3. Each of the end surface external electrodes 3 is formed to cover not only a corresponding one of the end surfaces C, but also a portion of the main surface A and a portion of the lateral surface B adjacent to the end surface C. Each of the second extension portions 52 of the lateral surface internal electrodes 50 are connected to a corresponding one of the lateral surface external electrodes 4. Each of the lateral surface external electrodes 4 is formed to cover not only the lateral surface B, but also a portion of the main surface A adjacent to the lateral surface B.

### Firing Step S5

The multilayer body 2 on which the end surface external electrodes 3 and the lateral surface external electrodes 4 are provided is heated at a set firing temperature for a predetermined time in a nitrogen atmosphere, for example. Thus, the end surface external electrodes 3 and the lateral surface external electrodes 4 are fired on the multilayer body 2, and the multilayer ceramic capacitor 1 shown in FIG. 1 is obtained.

### Advantageous Effects According to First Example Embodiment

According to the present example embodiment, it is possible to achieve the following advantageous effects.

According to the present example embodiment, the first extension portion 22 includes the first through holes 23 that each penetrate the first extension portion 22 in the lamination direction T, and the first pillar portions 27 that are each provided in a corresponding one of the first through holes 23, are each made of the same dielectric material as the dielectric layers 14, and each connecting the dielectric layers 14 adjacent to each other in the lamination direction T with the first extension portion 22 interposed therebetween. Furthermore, the dimension of each of the first pillar portions 27 in the length direction L in the cross section of FIG. 2 is, for example, about 20% or more and about 80% or less of the first extension distance D1.

Further, the second extension portion 52 includes the second through holes 53 that each penetrate the second extension portion 52 in the lamination direction T, and the second pillar portion 57 that are each provided in a corresponding one of the second through holes 53, are each made of the same dielectric material as the dielectric layers 14, and each connecting the dielectric layers 14 adjacent to each other in the lamination direction T with the second extension portion 52 interposed therebetween. Furthermore, the dimension of each of the second pillar portions 57 in the width direction W in the cross section of FIG. 3 is, for example, about 20% or more and about 80% or less of the second extension distance D2.

In this case, since it is possible for the pillar portions 27, 57 to reduce or prevent the dielectric layers 14 adjacent to each other in the lamination direction T with the extension portions 22, 52 interposed therebetween from being separated from each other, it is possible to effectively reduce or prevent delamination in the multilayer ceramic capacitor 1.

According to the present example embodiment, in the cross section of FIG. 2, when a point that is spaced apart from one end surface C from which the first extension portion 22 extends by a distance of, for example, about ⅔ of the first extension distance D1 in one first extension portion 22 is defined as a first reference point P1, it is preferable that the first pillar portion 27 provided in the first extension portion 22 is provided at a position including the first reference point P1.

Further, in the cross section of FIG. 3, when a point that is spaced apart from one lateral surface B from which the second extension portion 52 extends by a distance of, for example, about ⅔ of the second extension distance D2 in one second extension portion 52 is defined as a second reference point P2, it is preferable that the second pillar portion 57 provided in the second extension portion 52 is provided at a position including the second reference point P2.

In this case, it is possible to more effectively reduce or prevent delamination.

According to the present example embodiment, in a region of the multilayer body 2 adjacent to one end surface C, the plurality of first extension portions 22 and the plurality of dielectric layers 14 are alternately provided in the lamination direction T, and it is preferable that the first extension portions 22 including the first pillar portions 27 each provided at a position including the first reference point P1 and the dielectric layers 14 are alternately and continuously laminated for a number of layers accounting for, for example, about 3% or more of the total number of layers of the first extension portions 22 and the dielectric layers 14 alternately provided in the lamination direction T.

Further, in a region of the multilayer body 2 adjacent to one lateral surface B, the plurality of second extension portions 52 and the plurality of dielectric layers 14 are alternately provided in the lamination direction T, and it is preferable that the second extension portions 52 including the second pillar portions 57 each provided at a position including the second reference point P2 and the dielectric layers 14 are alternately and continuously laminated for a number of layers accounting for, for example, about 3% or more of the total number of layers of the second extension portions 52 and the dielectric layers 14 alternately provided in the lamination direction T.

In this case, it is possible to more effectively reduce or prevent delamination.

According to the present example embodiment, in the cross section of FIG. 2, it is preferable that the dimension in the length direction L of the first pillar portion 27 provided at the position including the first reference point P1 is, for example, about ⅕ or more and about ⅘ or less of the first extension distance D1 corresponding to the first reference point P1.

Further, in the cross section of FIG. 3, it is preferable that the dimension in the width direction W of the second pillar portion 57 provided at the position including the second reference point P2 is, for example, about ⅕ or more and about ⅘ or less of the second extension distance D2 corresponding to the second reference point P2.

In this case, it is possible to more effectively reduce or prevent delamination.

According to the present example embodiment, in a region adjacent to one end surface C in the cross section of FIG. 2, the first pillar portion 27 includes a main first pillar portion 28 provided at a position including the first reference point P1 and sub first pillar portions 29 provided closer to one end surface C than the main first pillar portion 28 is, and the first extension portion 22 including the main first pillar portion 28 and the sub first pillar portions 29 includes two or more sub first pillar portions 29 having a dimension in the length direction L smaller than the dimension in the length direction L of the main first pillar portion 28.

Further, in a region adjacent to one lateral surface B in the cross section of FIG. 3, the second pillar portion 57 includes a main second pillar portion 58 provided at a position including the second reference point P2 and sub second pillar portions 59 provided closer to one lateral surface B than the main second pillar portion 58 is, and the second extension portion 52 including the main second pillar portion 58 and the sub second pillar portions 59 includes two or more sub second pillar portions 59 having a dimension in the width direction W smaller than the dimension in the width direction W of the main second pillar portion 58.

In this case, it is possible to more effectively reduce or prevent delamination.

According to the present example embodiment, it is preferable that the number of end surface internal electrodes 20 each including the first pillar portion 27 provided at the position including the first reference point P1 is, for example, about ⅕ or more of the total number of end surface internal electrodes 20.

Further, it is preferable that the number of lateral surface internal electrodes 50 each including the second pillar portion 57 provided at the position including the second reference point P2 is, for example, about ⅕ or more of the total number of lateral surface internal electrodes 50.

In this case, it is possible to more effectively reduce or prevent delamination.

According to the present example embodiment, it is preferable that the dimension in the lamination direction T of each of the end surface internal electrodes 20 including the first pillar portion 27 provided at the position including the first reference point P1 is, for example, about 0.1 μm or more and about 5.0 μm or less.

Further, it is preferable that the dimension in the lamination direction T of each of the lateral surface internal electrodes 50 including the second pillar portion 57 provided at the position including the second reference point P2 is, for example, about 0.1 μm or more and about 5.0 μm or less.

In this case, it is possible to more effectively reduce or prevent delamination.

### Second Example Embodiment

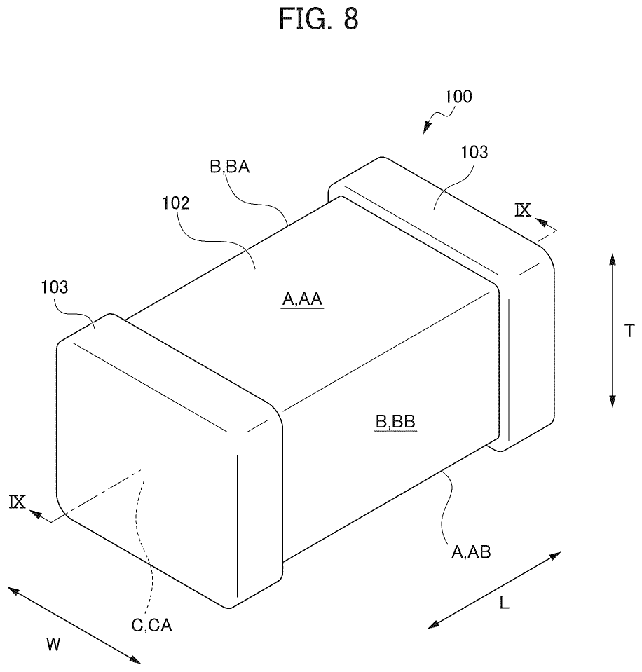

Next, a multilayer ceramic capacitor 100 according to a second example embodiment of the present invention will be described with reference to FIGS. 8 to 11. The multilayer ceramic capacitor 100 is a multilayer ceramic capacitor including a two-terminal configuration. The description will focus on differences from the multilayer ceramic capacitor 1 according to the first example embodiment, and the same reference numerals may be assigned to the same configurations as those of the multilayer ceramic capacitor 1 according to the first example embodiment, and descriptions thereof may be omitted.

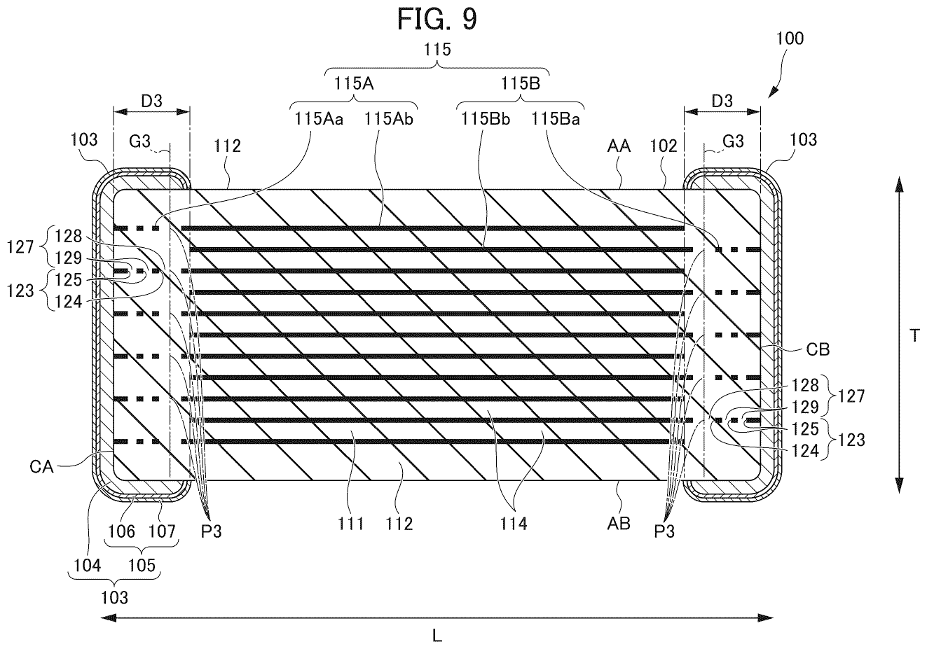

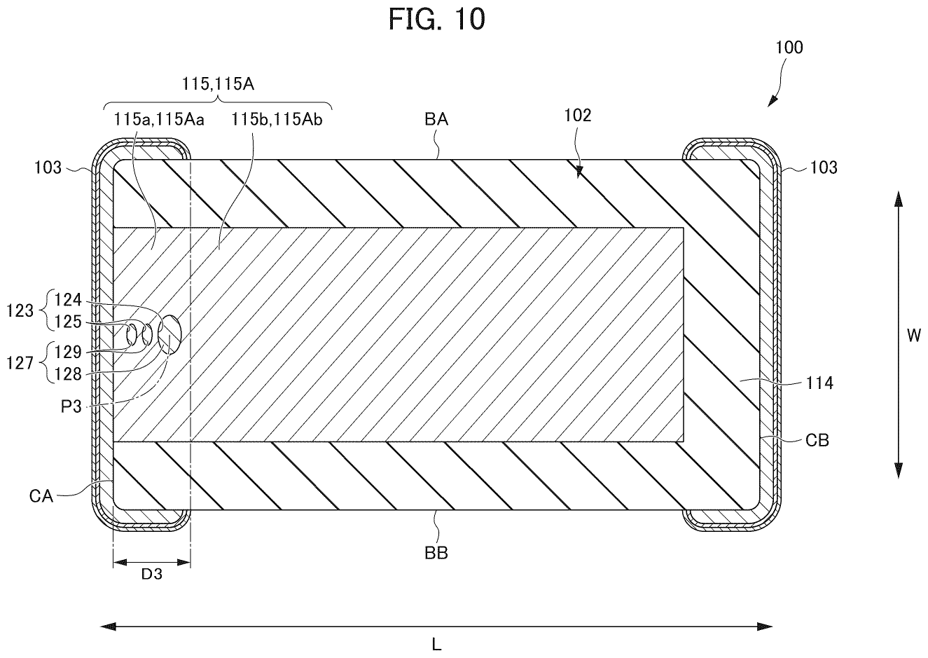

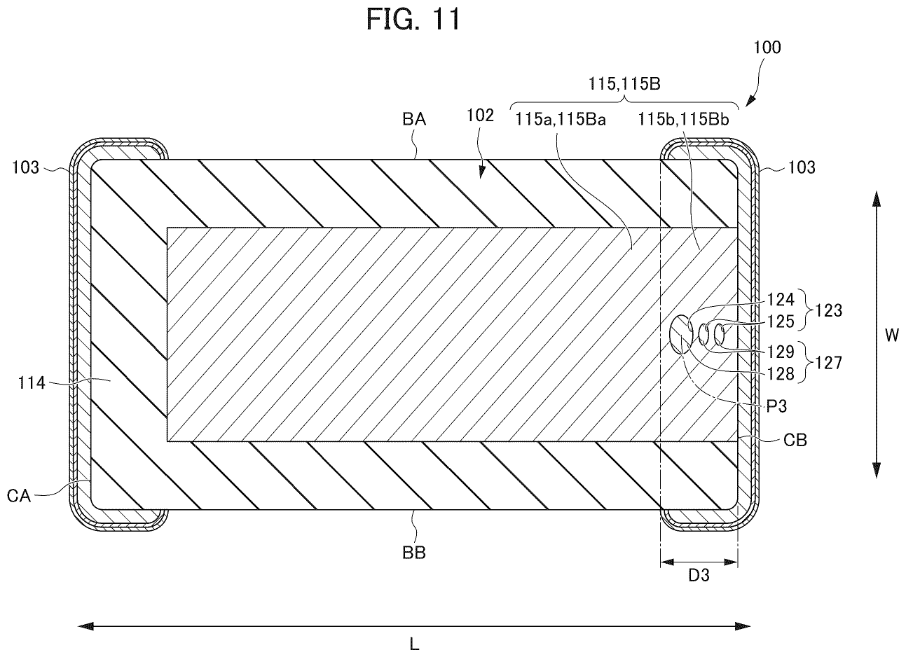

FIG. 8 is a schematic perspective view of the multilayer ceramic capacitor 100 according to the second example embodiment. FIG. 9 is a cross-sectional view of the multilayer ceramic capacitor 100 taken along the IX-IX direction in FIG. 8. FIG. 10 is a cross-sectional view along an internal electrode 115A adjacent to one end surface of the multilayer ceramic capacitor 100. FIG. 11 is a cross-sectional view along the internal electrode 115B adjacent to the other end surface of the multilayer ceramic capacitor 100. The cross-section of FIG. 9 is a cross-section parallel to the length direction L and the lamination direction T and passing through the middle portion of the extension portion 115b in the width direction W, and corresponds to a reference cross-section.

As shown in FIG. 8, the multilayer ceramic capacitor 100 has a rectangular or substantially rectangular parallelepiped shape and includes a multilayer body 102 and a pair of external electrodes 103.

The multilayer body 102 has a rectangular or substantially rectangular parallelepiped shape and includes an inner layer portion 111 and outer layer portions 112 provided on both sides of the inner layer portion 111 in the lamination direction T.

As shown in FIG. 9, the inner layer portion 11 includes a plurality of dielectric layers 114 and a plurality of internal electrodes 115 laminated along the lamination direction T.

The plurality of internal electrodes 115 include internal electrodes 115A that are each adjacent to one end surface and each extending toward the end surface CA, and internal electrodes 115B that are each adjacent to the other end surface and each extending toward the end surface CB. The internal electrodes 115A adjacent to the one end surface and the internal electrodes 115B adjacent to the other end surface are alternately provided in the lamination direction T.

As shown in FIG. 10, each of the internal electrodes 115A adjacent to the one end surface includes a counter portion 115Ab located in the middle portion between both end surfaces C, and an extension portion 115Aa that is adjacent to one end surface and extends from the counter portion 115Ab toward the end surface CA. The extension portion 115Aa adjacent to the one end surface is exposed at the end surface CA of the multilayer body 102. The internal electrodes 115A adjacent to the one end surface are spaced apart from the end surface CB and both lateral surfaces B.

As shown in FIG. 11, each of the internal electrodes 115B adjacent to the other end surface includes a counter portion 115Ba located in the middle portion between both end surfaces C, and an extension portion 115Bb that is adjacent to the other end surface and extends from the counter portion 115Ba toward the end surface CB. The extension portion 115Bb adjacent to the other end surface is exposed at the end surface CB of the multilayer body 102. The internal electrodes 115B adjacent to the other end surface are spaced apart from the end surface CA and both lateral surfaces B.

When there is no particular need to distinguish between them, the counter portion 115Aa and the counter portion 115Ba are collectively referred to as “counter portion 115a”, and the extension portion 115Ab adjacent to one end surface and the extension portion 115Bb adjacent to the other end surface are collectively referred to as “extension portion 115b”.

The two external electrodes 103 are provided on the end surfaces C, respectively. Each of the external electrodes 103 covers not only the end surface C, but also a portion of the main surface A and a portion of the lateral surface B adjacent to the end surface C. Each of the external electrodes 103 includes, for example, a base electrode layer 104, a Ni plated layer 105 provided on the base electrode layer 104, and a Sn plated layer 106 provided on the Ni plated layer 105. The internal electrodes 115A adjacent to one end surface (the extension portions 115Aa adjacent to one end surface) are connected to the external electrode 103 on the end surface CA. The internal electrodes 115B adjacent to the other end surface (the extension portions 115Bb adjacent to the other end surface) are connected to the external electrode 103 on the end surface CB.

Here, in the region near one end surface C in the cross section of FIG. 9, the distance that the extension portion 115a extends from the counter portion 115b toward the one end surface C from which the extension portion 115a extends is defined as an extension distance D3. A point that is spaced apart from the one end surface C from which the extension portion 115a extends by a distance of, for example, about ⅔ of the extension distance D3 is defined as a reference point P3 of the internal electrode 115 (extension portion 115a). A line in the lamination direction T connecting the reference points P3 adjacent to each other in the lamination direction T is defined as a gap line G3. It is preferable that the respective extension distances D3 are the same or substantially the same. In that case, each reference point P3 is located on the same straight line extending in the lamination direction T, and each gap line G3 defines a straight line extending in the lamination direction T.

The extension portion 115a includes a plurality of through holes 123 penetrating in the lamination direction T. In each through hole 123, the same dielectric as the material of the dielectric layer 114 is provided. In other words, the extension portion 115a includes pillar portions 127 that are each provided in a corresponding one of the through holes 123, are each made of the same dielectric as the material of the dielectric layer 114, and each connecting the dielectric layers 114 adjacent to each other in the lamination direction T with the extension portion 115a interposed therebetween. This makes it possible to reduce or prevent delamination between the extension portion 115a and the dielectric layer 114 adjacent to the extension portion 115a. The dimension in the length direction L of the through hole 123 and the pillar portion 127 in the cross section of FIG. 9 is, for example, about 20% or more and about 80% or less of the extension distance.

In one extension portion 115a, the through holes 123 include a main through hole 124 provided at a position including the reference point P3, and sub through holes 125 provided closer to one end surface C than the main through hole 124 is. In the one extension portion 115a, the pillar portions 127 include a main pillar portion 128 provided at a position including the reference point P3, and sub pillar portions 129 provided closer to the one end surface C from which the extension portion 115b extends than the main pillar portion 128 is. The main pillar portion 128 is located on the gap line G3. This makes it possible to more effectively reduce or prevent delamination between layers.

In the cross section of FIG. 9, it is preferable that the dimension in the length direction L of the main through hole 124 and the main pillar portion 128 is, for example, about ⅕ or more and about ⅘ or less of the extension distance D3 corresponding to the extension portion 115a provided with the main through hole 124 and the main pillar portion 128.

In the region near one end surface C of the multilayer body 102, it is preferable that a plurality of sub through holes 123 and a plurality of sub pillar portions 129 are provided in one extension portion 115a. Among the plurality of sub through holes 123 and the plurality of sub pillar portions 129, it is preferable that the dimension in the length direction L of each of at least two or more sub through holes 123 and sub pillar portions 129 is smaller than the dimension in the length direction L of the main through hole 122 and the main pillar portion 128 provided in the extension portion 115b.

In the region near one end surface C in the cross section of FIG. 9, the extension portions 115a and the dielectric layers 114 are alternately provided in the lamination direction T. It is preferable that the extension portions 115a including the pillar portions 127 on the reference points P3 (gap line G3) and the dielectric layers 114 are alternately and continuously laminated for a number of layers accounting for, for example, about 3% or more of the total number of layers of the extension portions 115a and the dielectric layers 114 alternately provided in the lamination direction T. In addition, the dielectric layer 114 sandwiched between two extension portions 115a is considered as one layer even if it is a mixture of dielectrics derived from a plurality of ceramic green sheets. Further, the number of dielectric layers 114 does not include the number of outer layer portions 112.

In the region near one end surface C in the cross section of FIG. 9, it is preferable that the number of internal electrodes 115 provided with the through holes 121 and the pillar portions 127 is, for example, about ⅕ or more of the total number of internal electrodes 115.

It is preferable that the through holes 123 and the pillar portions 127 are provided in the internal electrodes 115 adjacent to any of the main surfaces A. Specifically, among the internal electrodes 115 included in each of the regions adjacent to a corresponding one of both main surfaces A among the regions obtained by dividing the multilayer ceramic capacitor 1 into three equal or substantially equal portions in the lamination direction T, it is preferable that at least one internal electrode 115 includes the through holes 123 and the pillar portions 127. By providing the pillar portions 127 at positions adjacent to any of the main surfaces A, it is possible to more effectively reduce or prevent delamination.

It is preferable that the dimension in the lamination direction T of the internal electrode 115 provided with the pillar portion 127 (main pillar portion 128) on the reference point P3 (gap line G3) is, for example, about 0.1 μm or more and about 5.0 μm or less.

### Manufacturing Method of Multilayer Ceramic Capacitor 100

Next, an example of a manufacturing method of the multilayer ceramic capacitor 100 according to the second example embodiment will be described.

First, ceramic green sheets are prepared on which patterns of the internal electrodes 115 are printed with an electrically conductive paste on ceramic green sheets for lamination formed by shaping ceramic slurry into sheet form. At this time, the through holes 123 can be formed in the internal electrodes 115 by using a printing pattern of the internal electrodes 115 in which the through holes 123 are provided in advance.

Next, a plurality of ceramic green sheets are stacked such that the internal electrode patterns are shifted by about half a pitch in the length direction between adjacent ceramic green sheets. Next, ceramic green sheets for manufacturing outer layer portions are provided on the upper and lower sides, and thermocompression bonded to form a mother block. Next, the mother block is cut and divided in the length direction L and the width direction W to manufacture a plurality of rectangular parallelepiped multilayer bodies 102.

Next, external electrodes 103 are formed on both end surfaces C of the multilayer body 102. The multilayer body 102 with the external electrodes 103 provided thereon is heated at a set firing temperature in, for example, a nitrogen atmosphere for a predetermined time. Thus, the external electrodes 103 are fired on the multilayer body 102, and the multilayer ceramic capacitor 100 shown in FIG. 1 is obtained.

### Advantageous Effects of Second Example Embodiment

According to the present example embodiment, it is possible to achieve the following advantageous effects.

According to the present example embodiment, the extension portion 115b includes the through holes 121 penetrating the extension portion 115b in the lamination direction T, and the pillar portions 127 that are each provided in a corresponding one of the through holes 121, are each made of the same dielectric material as the dielectric layers 114, and each connecting the dielectric layers 114 adjacent to each other in the lamination direction T with the extension portion 115b interposed therebetween, and in the cross section of FIG. 9, the dimension in the length direction L of each of the pillar portions 127 is, for example, about 20% or more and about 80% or less of the extension distance D3.

In this case, since it is possible for the pillar portions 127 to reduce or prevent the dielectric layers 114 adjacent to each other in the lamination direction T with the extension portion 115b interposed therebetween from being spaced away from each other, it is possible to suitably suppress delamination between layers in the multilayer ceramic capacitor 100, which is a two-terminal multilayer ceramic capacitor.

According to the present example embodiment, in the cross section of FIG. 9, when a point that is spaced apart from one end surface C from which the extension portion 115b extends by a distance of ⅔ of the extension distance D3 in one extension portion 115b is defined as a reference point P3, the pillar provided in the extension portion 115b are each portions 127 provided at a position including the reference point P3.

In this case, it is possible to suppress delamination more suitably.

According to the present example embodiment, in the region near one end surface C of the multilayer body 102, the plurality of extension portions 115b and the plurality of dielectric layers 114 are alternately provided in the lamination direction T, and it is preferable that the extension portions 115b including the pillar portions 127 each provided at a position including the reference point P3, and the dielectric layers 114 are alternately and continuously laminated for a number of layers accounting for 3% or more of the total number of layers of the extension portions 115b and the dielectric layers 114 alternately provided in the lamination direction T.

In this case, it is possible to more effectively reduce or prevent delamination.

According to the present example embodiment, in the cross section of FIG. 9, the dimension in the length direction L of the pillar portion 127 provided at the position including the reference point P3 is, for example, preferably about ⅕ or more and about ⅘ or less of the extension distance D3 corresponding to the reference point P3.

In this case, it is possible to more effectively reduce or prevent delamination.

According to the present example embodiment, in the region near one end surface C in the cross section of FIG. 9, the pillar portions 127 include a main pillar portion 128 provided at a position including the reference point P3 and sub pillar portions 129 provided closer to one end surface C than the main pillar portion 128 is, and the extension portion 115b having the main pillar portion 128 and the sub pillar portions 129 includes two or more sub pillar portions 129 each having a dimension in the length direction L smaller than the dimension in the length direction L of the main pillar portion 128.

In this case, it is possible to more effectively reduce or prevent delamination.

According to the present example embodiment, in the region adjacent to one end surface C of the multilayer body 102, the number of internal electrodes 115 including the pillar portions 127 each provided at a position including the reference point P3 is, for example, preferably about ⅕ or more of the total number of internal electrodes 115 connected to the one end surface C.

In this case, it is possible to more effectively reduce or prevent delamination.

According to the present example embodiment, the dimension in the lamination direction T of each of the internal electrodes 115 having the pillar portion 127 provided at a position including the reference point P3 is, for example, preferably about 0.1 μm or more and about 5.0 μm or less.

In this case, it is possible to more effectively reduce or prevent delamination.

While example embodiments of the present invention have been described above, the present invention is not limited to the above-described example embodiments, and various changes and modifications can be made.

In the first example embodiment described above, the multilayer ceramic capacitor 1 is a three-terminal multilayer ceramic capacitor, but the multilayer ceramic capacitor may be a multi-terminal having more external electrodes. In that case, for example, the lateral surface B includes a plurality of external electrodes provided adjacent to each other in the length direction. The internal electrodes include internal electrodes extending toward the two lateral surfaces B, and one of the internal electrodes extending toward the two lateral surfaces B includes a plurality of extension portions provided adjacent to each other in the length direction L. The extension portions extend toward the lateral surface B and are connected to the external electrodes provided on the lateral surface B. It is possible to obtain the desired advantageous effects even in such a multi-terminal multilayer ceramic capacitor.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of dielectric layers that are laminated, a plurality of internal electrodes each on a corresponding one of the plurality of dielectric layers, two main surfaces opposed to each other in a lamination direction, two lateral surfaces opposed to each other in a width direction orthogonal or substantially orthogonal to the lamination direction, and two end surfaces opposed to each other in a length direction orthogonal or substantially orthogonal to the lamination direction and the width direction; and
external electrodes connected to the plurality of internal electrodes on at least one of the two lateral surfaces or the two end surfaces; wherein
each of the plurality of internal electrodes includes a counter portion opposed to an adjacent one of the plurality of internal electrodes in the lamination direction, and an extension portion extending from the counter portion to at least one surface among the two lateral surfaces or the two end surfaces;
the extension portion includes a through hole penetrating through the extension portion in the lamination direction, and a pillar portion in the through hole, made of a same dielectric material as a dielectric material of the plurality of dielectric layers, and connecting dielectric layers adjacent to each other in the lamination direction among the plurality of dielectric layers with the extension portion interposed therebetween; and
when a direction in which the extension portion including the pillar portion extends from the counter portion is defined as an extension direction corresponding to the pillar portion, a cross section parallel or substantially parallel to the extension direction and the lamination direction and passing through a middle portion of the extension portion in a direction orthogonal or substantially orthogonal to the extension direction and the lamination direction is defined as a reference cross section, and a distance that the extension portion extends from the counter portion toward one of the two lateral surfaces or the two end surfaces toward which the extension portion extends in the reference cross section is defined as an extension distance, a dimension of the pillar portion in the extension direction in the reference cross section is about 20% or more and about 80% or less of the extension distance.

2. A multilayer ceramic capacitor comprising:
a multilayer body including a plurality of dielectric layers that are laminated and a plurality of internal electrodes each on a corresponding one of the plurality of dielectric layers, two main surfaces opposed to each other in a lamination direction, two lateral surfaces opposed to each other in a width direction orthogonal or substantially orthogonal to the lamination direction, and two end surfaces opposed to each other in a length direction orthogonal or substantially orthogonal to the lamination direction and the width direction;
two end surface external electrodes each on a corresponding one of the two end surfaces; and
two lateral surface external electrodes each on a corresponding one of the two lateral surfaces; wherein
the plurality of internal electrodes include end surface internal electrodes connected to the two end surface external electrodes and lateral surface internal electrodes connected to the two lateral surface external electrodes;
each of the end surface internal electrodes includes a first counter portion opposed to an adjacent one of the lateral surface internal electrodes in the lamination direction, and two first extension portions each extending from the first counter portion and each exposed at a corresponding one of the two end surfaces;
each of the lateral surface internal electrodes includes a second counter portion opposed to an adjacent one of the end surface internal electrodes in the lamination direction, and two second extension portions each extending from the second counter portion and each exposed at a corresponding one of the two lateral surfaces;
each of the two first extension portions includes a first through hole penetrating through the first extension portion in the lamination direction, and a first pillar portion in the first through hole, made of a same dielectric material as a dielectric material of the dielectric layers, and connecting dielectric layers adjacent to each other in the lamination direction among the plurality of dielectric layers with the first extension portion interposed therebetween; and
when a cross section parallel or substantially parallel to the length direction and the lamination direction and passing through a middle portion of each of the two first extension portions in the width direction is defined as a first reference cross section, and a distance that one of the two first extension portions extends from the first counter portion toward a corresponding one of the two end surfaces in the first reference cross section is defined as a first extension distance, a dimension of the first pillar portion in the length direction in the first reference cross section is about 20% or more and about 80% or less of the first extension distance.

3. The multilayer ceramic capacitor according to claim 2, wherein
each of the two second extension portions includes a second through hole penetrating through the second extension portion in the lamination direction, and a second pillar portion in the second through hole, made of a same dielectric material as a dielectric material of the dielectric layers, and connecting dielectric layers adjacent to each other in the lamination direction among the plurality of dielectric layers with the second extension portion interposed therebetween; and
when a cross section parallel or substantially parallel to the width direction and the lamination direction and passing through a middle portion of each of the two second extension portions in the length direction is defined as a second reference cross section, and a distance that one of the two second extension portions extends from the second counter portion toward a corresponding one of the two end surfaces in the second reference cross section is defined as a second extension distance, a dimension of the second pillar portion in the width direction in the second reference cross section is about 20% or more and about 80% or less of the second extension distance.

4. A multilayer ceramic capacitor comprising:
a multilayer body including a plurality of dielectric layers that are laminated and a plurality of internal electrodes each on a corresponding one of the plurality of dielectric layers, two main surfaces opposed to each other in a lamination direction, two lateral surfaces opposed to each other in a width direction orthogonal or substantially orthogonal to the lamination direction, and two end surfaces opposed to each other in a length direction orthogonal or substantially orthogonal to the lamination direction and the width direction;
two end surface external electrodes each on a corresponding one of the two end surfaces; and
two lateral surface external electrodes each on a corresponding one of the two lateral surfaces; wherein
the plurality of internal electrodes include end surface internal electrodes connected to the two end surface external electrodes and lateral surface internal electrodes connected to the two lateral surface external electrodes;
each of the end surface internal electrodes includes a first counter portion opposed to an adjacent one of the lateral surface internal electrodes in the lamination direction, and two first extension portions each extending from the first counter portion and each exposed at a corresponding one of the two end surfaces;
each of the lateral surface internal electrodes includes a second counter portion opposed to an adjacent one of the end surface internal electrodes in the lamination direction, and two second extension portions each extending from the second counter portion and each exposed at a corresponding one of the two lateral surfaces;
each of the two second extension portions includes a second through hole penetrating through the second extension portion in the lamination direction, and a second pillar portion in the second through hole, made of a same dielectric material as a dielectric material of the dielectric layers, and connecting dielectric layers adjacent to each other in the lamination direction among the plurality of dielectric layers with the second extension portion interposed therebetween; and
when a cross section parallel or substantially parallel to the length direction and the lamination direction and passing through a middle portion of the multilayer body in the width direction is defined as a second reference cross section, and a distance that one of the two second extension portions extends from the second counter portion toward a corresponding one of the two end surfaces in the second reference cross section is defined as a second extension distance, a dimension of the second pillar portion in the length direction in the second reference cross section is about 20% or more and about 80% or less of the second extension distance.

5. The multilayer ceramic capacitor according to claim 2, wherein, when a point spaced apart from one of the two end surfaces toward which the first extension portion extends by a distance of about ⅔ of the first extension distance in the first extension portion in the first reference cross section is defined as a first reference point, the first pillar portion in the first extension portion is at a position including the first reference point.

6. The multilayer ceramic capacitor according to claim 3, wherein, when a point spaced apart from one of the two lateral surfaces toward which the second extension portion extends by a distance of about ⅔ of the second extension distance in the second extension portion in the second reference cross section is defined as a second reference point, the second pillar portion in the second extension portion is at a position including the second reference point.

7. The multilayer ceramic capacitor according to claim 5, wherein
in a region of the multilayer body adjacent to one of the two end surfaces:
a plurality of first extension portions and a plurality of dielectric layers are alternately provided in the lamination direction; and
first extension portions including first pillar portions each at a position including the first reference point, and dielectric layers of the plurality of dielectric layers are alternately and continuously laminated in about 3% or more of a total number of layers of the first extension portions and the dielectric layers alternately provided in the lamination direction.

8. The multilayer ceramic capacitor according to claim 6, wherein
in a region of the multilayer body adjacent to one of the two lateral surfaces:
a plurality of second extension portions and a plurality of dielectric layers are alternately provided in the lamination direction; and
second extension portions including second pillar portions each at a position including the second reference point, and dielectric layers of the plurality of dielectric layers are alternately and continuously laminated in about 3% or more of a total number of layers of the second extension portions and the dielectric layers alternately provided in the lamination direction.

9. The multilayer ceramic capacitor according to claim 5, wherein, in the first reference cross section, a dimension in the length direction of the first pillar portion at a position including the first reference point is about ⅕ or more and about ⅘ or less of the first extension distance corresponding to the first reference point.

10. The multilayer ceramic capacitor according to claim 6, wherein, in the second reference cross section, a dimension in the width direction of the second pillar portion at a position including the second reference point is about ⅕ or more and about ⅘ or less of the second extension distance corresponding to the second reference point.

11. The multilayer ceramic capacitor according to claim 5, wherein
in a region adjacent to one of the two end surfaces in the first reference cross section:
the first pillar portion includes a main first pillar portion at a position including the first reference point and a sub first pillar portion closer to the one of the two end surfaces than the main first pillar portion is; and
one of the two first extension portions including the main first pillar portion and the sub first pillar portion includes two or more sub first pillar portions each with a smaller dimension in the length direction than a dimension of the main first pillar portion in the length direction.

12. The multilayer ceramic capacitor according to claim 6, wherein
in a region adjacent to one of the two lateral surfaces in the second reference cross section:
the second pillar portion includes a main second pillar portion at a position including the second reference point and a sub second pillar portion closer to the one of the two lateral surfaces than the main second pillar portion is; and
one of the two second extension portions including the main second pillar portion and the sub second pillar portion includes two or more sub second pillar portions each with a smaller dimension in the width direction than a dimension of the main second pillar portion in the width direction.

13. The multilayer ceramic capacitor according to claim 5, wherein a number of the end surface internal electrodes including the first pillar portion at the position including the first reference point is about ⅕ or more of a total number of the end surface internal electrodes.

14. The multilayer ceramic capacitor according to claim 6, wherein a number of the lateral surface internal electrodes including the second pillar portion at the position including the second reference point is about ⅕ or more of a total number of the lateral surface internal electrodes.

15. The multilayer ceramic capacitor according to claim 5, wherein a dimension in the lamination direction of each of the end surface internal electrodes each including the first pillar portion at the position including the first reference point is about 0.1 μm or more and about 5.0 μm or less.

16. The multilayer ceramic capacitor according to claim 6, wherein a dimension in the lamination direction of each of the lateral surface internal electrodes each including the second pillar portion at the position including the second reference point is about 0.1 μm or more and about 5.0 μm or less.

17. A multilayer ceramic capacitor comprising:
a multilayer body including a plurality of dielectric layers that are laminated, and a plurality of internal electrodes each on a corresponding one of the plurality of dielectric layers, two main surfaces opposed to each other in a lamination direction, two lateral surfaces opposed to each other in a width direction orthogonal or substantially orthogonal to the lamination direction, and two end surfaces opposed to each other in a length direction orthogonal or substantially orthogonal to the lamination direction and the width direction; and
two external electrodes each on a corresponding one of the two end surfaces; wherein
each of the plurality of internal electrodes is connected to one of the two external electrodes and includes a counter portion opposed to an adjacent one of the internal electrodes in the lamination direction, and an extension portion extending from the counter portion and exposed at one of the two end surfaces;
the extension portion includes a through hole penetrating through the extension portion in the lamination direction, and a pillar portion in the through hole, made of a same dielectric material as a dielectric material of the plurality of dielectric layers, and connecting dielectric layers adjacent to each other in the lamination direction among the plurality of dielectric layers with the extension portion interposed therebetween; and
when a cross section parallel or substantially parallel to the length direction and the lamination direction and passing through a middle portion of the extension portion in the width direction is defined as a reference cross section, and a distance that the extension portion extends from the counter portion toward one of the end surfaces in the reference cross section is defined as an extension distance, a dimension of the pillar portion in the length direction in the reference cross section is about 20% or more and about 80% or less of the extension distance.

18. The multilayer ceramic capacitor according to claim 17, wherein, when a point spaced apart from one of the two end surfaces toward which the extension portion extends by a distance of about ⅔ of the extension distance in the extension portion in the reference cross section is defined as a reference point, the pillar portion in the extension portion is at a position including the reference point.

19. The multilayer ceramic capacitor according to claim 18, wherein
in a region of the multilayer body adjacent to one of the two end surfaces:
a plurality of extension portions and a plurality of dielectric layers are alternately provided in the lamination direction; and
extension portions including pillar portions each at a position including the reference point, and dielectric layers of the plurality of dielectric layers are alternately and continuously laminated in about 3% or more of a total number of layers of the extension portions and the dielectric layers alternately provided in the lamination direction.

20. The multilayer ceramic capacitor according to claim 18, wherein, in the reference cross section, a dimension in the length direction of the pillar portion at a position including the reference point is about ⅕ or more and about ⅘ or less of the extension distance corresponding to the reference point.

21. The multilayer ceramic capacitor according to claim 18, wherein
in a region adjacent to one of the two end surfaces in the reference cross section:
the pillar portion includes a main pillar portion at a position including the reference point and a sub pillar portion closer to the one of the two end surfaces than the main pillar portion is; and
the extension portion including the main pillar portion and the sub pillar portion includes two or more sub pillar portions each with a smaller dimension in the length direction than a dimension of the main pillar portion in the length direction.

22. The multilayer ceramic capacitor according to claim 18, wherein, in a region of the multilayer body adjacent to one of the two end surfaces, a number of the internal electrodes including the pillar portion at the position including the reference point is about ⅕ or more of a total number of the internal electrodes connected to the one of the two end surfaces.

23. The multilayer ceramic capacitor according to claim 18, wherein a dimension in the lamination direction of each of the internal electrodes each including the pillar portion at the position including the reference point is about 0.1 μm or more and about 5.0 μm or less.
